(19) United States
(12) Patent Application Publication
(10) Pub. No.: US 2019/0050298 A1
(43) Pub. Date: Feb. 14, 2019

(54) METHOD AND APPARATUS FOR IMPROVING DATABASE RECOVERY SPEED USING LOG DATA ANALYSIS

(71) Applicant: TmaxData Co., Ltd., Gyeonggi-do (KR)

(72) Inventors: Jeongho NA, Gyeonggi-do (KR); Hak Ju KIM, Gyeonggi-do (KR); Hyungrak JO, Gyeonggi-do (KR); Seung-Bin BAE, Gyeonggi-do (KR); Eunmo YANG, Ulsan (KR)

(21) Appl. No.: 15/695,972

(22) Filed: Sep. 5, 2017

(30) Foreign Application Priority Data
Aug. 10, 2017 (KR) 10-2017-0101699

(51) Int. Cl. G06F 11/14; G06F 17/30

(52) U.S. Cl. CPC G06F 11/1469; G06F 11/1451; G06F 11/1471; G06F 17/30309

(57) ABSTRACT

Disclosed is a method for improving a database recovery speed using a log data analysis according to a first exemplary embodiment of the present disclosure, including: reading at least one redo log file and loading recovery log data on a storage unit; analyzing the loaded recovery log data and generating a plurality of sub log data groups, the plurality of respective sub log data groups being associated with specific data blocks and the specific data blocks associated with the plurality of respective sub log data groups being different from each other; and generating at least one adjacent log data group based on positional information of the specific data blocks associated with the plurality of respective sub log data groups, each of the at least one adjacent log data group including at least one sub log data group.

Disclosed is a database management server providing a method for improving a database recovery speed using a log data analysis according to a second exemplary embodiment of the present disclosure, including: a log file reading unit reading at least one redo log file; a data loading unit loading recovery log data on a storage unit; a sub log data group generating unit analyzing the loaded recovery log data and generating a plurality of sub log data groups, the plurality of respective sub log data groups being associated with specific data blocks and the specific data blocks associated with the plurality of respective sub log data groups being different from each other; and an adjacent log data group generating unit generating at least one adjacent log data group based on positional information of the specific data blocks associated with the plurality of respective sub log data groups, each of the at least one adjacent log data group including at least one sub log data group.

Disclosed is a computer-readable medium including a computer program including encoded commands, which is configured to cause one or more processors to perform the operations when the computer program is executed by the one or more processors of a computer system according to a third exemplary embodiment of the present disclosure, the operations including: an operation of reading at least one redo log file and loading recovery log data on a storage unit; an operation of analyzing the loaded recovery log data and generating a plurality of sub log data groups, the plurality of respective sub log data groups being associated with specific data blocks and the specific data blocks associated with the plurality of respective sub log data groups being different from each other; and an operation of generating at least one adjacent log data group based on positional information of the specific data blocks associated with the plurality of respective sub log data groups, each of the at least one adjacent log data group including at least one sub log data group.

### CROSS-REFERENCE TO RELATED APPLICATIONS

This application claims priority to and the benefit of Korean Patent Application No. 10-2017-0101699 filed in the Korean Intellectual Property Office on Aug. 10, 2017, the entire contents of which are incorporated herein by reference.

### TECHNICAL FIELD

The present disclosure relates to a database recovery, and more particularly, to a method for rapidly and efficiently performing a recovery by using a data file and a redo log at the time of performing the recovery when a fail occurs in a database in which write-ahead-logging needs to be guaranteed.

### BACKGROUND ART

A recovery of a database in the related art is performed by a manner that just reads a redo log file, selects a data block to be recovered based on a corresponding log, reads the corresponding block from a data file, and thereafter, applies a redo log in order to recover the database.

However, in the case where the recovery is performed, since the data file needs to be read by accessing blocks which are randomly scattered at the time of reading the data file from a disk, disk access efficiency may be lowered. In addition, when multiple redo logs are applied to one data block while the read data block is loaded on a memory cache, a total recovery operation time may be delayed due to unnecessary multiple accesses to the disk. Moreover, there is a problem in that asynchronous input/output (AIO) cannot be performed assuming that only an address of one block is known at time of reading the data block.

Therefore, there is a need for a method that can reduce the total database recovery time by efficiently accessing the disk during a database recovery process.

### SUMMARY OF THE INVENTION

The present disclosure has been made in an effort to provide a method for improving a database recovery speed using log data analysis, which efficiently performs an access to a disk in order o reduce a total database recovery time.

A first exemplary embodiment of the present disclosure provides a method for improving a database recovery speed using a log data analysis, including: reading at least one redo log file and loading recovery log data on a storage unit; analyzing the loaded recovery log data and generating a plurality of sub log data groups, the plurality of respective sub log data groups being associated with specific data blocks and the specific data blocks associated with the plurality of respective sub log data groups being different from each other; and generating at least one adjacent log data group based on positional information of the specific data blocks associated with the plurality of respective sub log data groups, each of the at least one adjacent log data group including at least one sub log data group.

A second exemplary embodiment of the present disclosure provides a database management server providing a method for improving a database recovery speed using a log data analysis, including: a log file reading unit reading at least one redo log file; a data loading unit loading recovery log data on a storage unit; a sub log data group generating unit analyzing the loaded recovery log data and generating a plurality of sub log data groups, the plurality of respective sub log data groups being associated with specific data blocks and the specific data blocks associated with the plurality of respective sub log data groups being different from each other; and an adjacent log data group generating unit generating at least one adjacent log data group based on positional information of the specific data blocks associated with the plurality of respective sub log data groups, each of the at least one adjacent log data group including at least one sub log data group.

A third exemplary embodiment of the present disclosure provides a computer-readable medium including a computer program including encoded commands, which is configured to cause one or more processors to perform the following operations when the computer program is executed by the one or more processors of a computer system, the operations including: an operation of reading at least one redo log file and loading recovery log data on a storage unit; an operation of analyzing the loaded recovery log data and generating a plurality of sub log data groups, the plurality of respective sub log data groups being associated with specific data blocks and the specific data blocks associated with the plurality of respective sub log data groups being different from each other; and an operation of generating at least one adjacent log data group based on positional information of the specific data blocks associated with the plurality of respective sub log data groups, each of the at least one adjacent log data group including at least one sub log data group.

According to an exemplary embodiment of the present disclosure, a method for improving a database recovery speed using log data analysis efficiently performs an access to a disk to reduce a total database recovery time.

### BRIEF DESCRIPTION OF THE DRAWINGS

Various aspects are now described with reference to the drawings and like reference numerals are generally used to designate like elements. In the following exemplary embodiments, for a description purpose, multiple specific detailed matters are presented to provide general understanding of one or more aspects. However, it will be apparent that the aspect(s) can be executed without the detailed matters.

FIG. 1 illustrates a database management system according to an exemplary embodiment of the present disclosure.

FIG. 2 illustrates a step of improving a recovery speed of a database by using log data sorting according to an exemplary embodiment of the present disclosure.

FIG. 3 illustrates internal components of a database management server according to an exemplary embodiment of the present disclosure.

FIG. 4 illustrates a method in which a database management server generates a sub log data group and an adjacent log data group by sorting recovery log data according to an exemplary embodiment of the present disclosure.

FIG. 5 illustrates a method in which a database management server acquires a plurality of adjacent data blocks by an asynchronous method according to an exemplary embodiment of the present disclosure.

### DETAILED DESCRIPTION

Various exemplary embodiments anchor aspects will be now disclosed with reference to drawings. In the following description, for the purpose of a description, multiple detailed matters will be disclosed in order to help comprehensive appreciation of one or more aspects. However, those skilled in the art will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof.

Various aspects and features will be presented by a system which can include one or more apparatuses, terminals, servers, devices, components, and/or modules. It should also be appreciated and recognized that various systems can include additional apparatuses, terminals, servers, devices, components, and/or modules and/or that the various systems cannot include all of apparatuses, terminals, servers, devices, components, modules, and the like discussed in association with the drawings.

In “embodiment”, “example”, “aspect”, “illustration”, and the like used in the specification, it may not be construed that a predetermined aspect or design which is described is more excellent or advantageous than other aspects or designs. ‘Component’, ‘module’, ‘system’, ‘interface’, and the like which are terms used below generally mean computer-related entities and mean, for example, hardware, a combination of the hardware and software, or the software.

The term “or” is intended to mean not exclusive “or” but inclusive “or”. That is, when not separately specified or not clear in terms of a context, a sentence “X uses A or B” is intended to mean one of natural inclusive substitutions. That is, “X uses A or B” may be applied to all of the case where X uses A, the case where X uses B, and the case where X uses both A and B. Further, it should be understood that the term “and/or” used in the specification designates and includes all available combinations of one or more items among enumerated related items.

The word “comprises” and/or “comprising” means that the corresponding feature and/or component is present, but it should be appreciated that presence or addition of one or more other features, components, and/or a group thereof is not excluded. Further, when not separately specified or not clear in terms of the context that a singular form is indicated, it should be construed that a singular form generally means “one or more” in the present specification and the claims.

The computer-readable medium in the present specification may include all kinds of storage media storing programs and data so as to he readable by the computer system. The computer readable media in the present disclosure may include both computer readable storage media and computer readable transmission media. According to an aspect of the present disclosure, the computer-readable storage media may include a read only memory (ROM), a random access memory (RAM), a compact disk (CD)-ROM, a digital video disk (DVD)-ROM, a magnetic tape, a floppy disk, an optical data storage device, and the like. Further, the computer readable transmission media may include a predetermined medium of a type which is transmittable, which is implemented in a type of a carrier wave (e.g., transmissions through the Internet) Additionally, the computer readable media are distributed to systems connected through network to store computer readable codes and/or commands in a distribution scheme.

Prior to describing detailed contents for carrying out the present disclosure, it should be noted that configurations not directly associated with the technical gist of the present disclosure are omitted without departing from the technical gist of the present disclosure. Further, terms or words used in the present specification and claims should be interpreted as meanings and concepts which match the technical spirit of the present disclosure based on a principle in which the inventor can define appropriate concepts of the terms in order to describe his/her invention by a best method.

In the present disclosure, a database means a system that stores data associated with each other in a computer processible format. The database may store data and answer a question of a user and the data stored in the database may be changed. The database may store new data and perform operations of deleting and changing the existing data.

In the present disclosure, a redo log file means a file that collects and records information (log data) required for a recovery when a fail occurs in the database. The redo log file may be read from a database management server and may include recovery log data.

In the present disclosure, the log data means data in which contents associated with a data change are recorded, such as transaction or a change of operation information during operating the database.

Types of the recovery performed by using the log data may include a media recovery used for recovering the database when a media fail physically occurs due to a damage of a disk, an instance recovery for preparing for loss of transaction data when an instance is abnormally terminated, and the like and are not limited thereto.

The log data may include various information on at least one data block.

For example, the log data may include change time information of a data block. For example, the log data may include information indicating when a specific data block is changed.

The log data may include recording time information of the data block. For example, the log data may include information indicating when the specific data block is recorded in the persistent storage medium 3000.

The log data may include positional information of the data block. Herein, the positional information may include various information to identify a position of the data block. For example, the log data may include block address information indicating in which part of the persistent storage medium 3000 the specific data block is recorded and is not limited thereto and may include various information.

In the present disclosure, a block may mean a chunk of data. For example, the block may include one table storing the data and include a plurality of tables. Further, the data included in one table may be represented by a plurality of blocks.

The block may have various sizes. For example, the block may have sizes including 10 kb, 100 kb, 1 mega byte, 2 mega bytes, 3 mega bytes, 4 mega bytes, and the like and is not limited thereto.

Hereinafter, exemplary embodiments of the present disclosure will be described in detail with reference to the accompanying drawings.

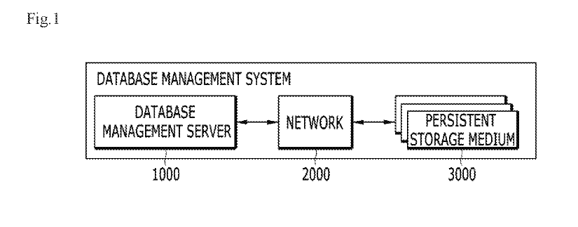

FIG. 1 illustrates a database management system according to an exemplary embodiment of the present disclosure.

According to the exemplary embodiment of the present disclosure, the database management system may include a database management server 1000, a network 2000, and a persistent storage medium 3000.

The database management server 1000 may include a predetermined type of computer system or computer device such as a microprocessor, a mainframe computer, a digital single processor, a portable device, and a device controller.

The database management server 1000 may include a storage unit 200. The database management server 1000 may perform a database recovery by using the storage unit 200. For example, when the database management server 1000 reads a redo log file, the database management server 1000 may load recovery log data in at least a part of the storage unit 200, read specific data blocks from the persistent storage medium 3000, and store the read data blocks in at least a part of the storage unit 200. In addition, the recovery log data may be applied to the specific data blocks stored in the storage unit 200.

The storage unit 200 as a primary storage device directly accessed by a control unit 100, such as a random access memory (RAM) including a dynamic random access memory (DRAM), a static random access memory (SRAM), etc., may mean a volatile storage device in which stored information is momentarily erased when power is turned off, but is not limited thereto. The storage unit 200 may be controlled by the control unit 100.

The database management server 1000 and the persistent storage medium 3000 may transmit and receive data through a network 2000. The network 2000 may include a wired network and wireless network and is not limited thereto.

The persistent storage medium 3000 may include a non-volatile storage medium which may continuously store predetermined data. For example, the persistent storage medium 3000 may include a storage device based on a flash memory and/or a battery back-up memory in addition to a disk, an optical disk, and a magneto-optical storage device and is not limited thereto.

The database management server 1000 reads at least one redo log file to load the recovery log data on the storage unit 200. In addition, the database management server 1000 analyzes the loaded recovery log data to sort the recovery log data for each specific data block associated with each recovery log data. The database management server 1000 may acquire the specific data blocks from the persistent storage medium 3000 based on the sorted recovery log data. The recovery log data which are sorted in the respective specific data blocks acquired by the database management server 1000 are sequentially applied, and as a result, a recovery may be performed. In this case, the recovery log data applied to the respective specific data blocks may be associated with the respective specific data blocks.

Herein, the database management server 1000 may acquire adjacent data blocks at one time based on positioned information of the respective data blocks associated with the sorted recovery log data. In this case, since the database management server 1000 does not individually acquire the respective adjacent specific data blocks but acquires the specific data blocks at one time, the number of access times to the persistent storage medium 3000 may be reduced.

In the course of the database recovery, the time for the database management server 1000 to acquire data blocks in the persistent storage medium 3000 occupies the largest percentage. Accordingly, the overall database recovery time can be effectively reduced by the database management server 1000 at once acquiring several specific data blocks adjacent to each other in the persistent storage medium 3000.

The database management server 1000 may acquire the data blocks from the persistent storage medium 3000 in an asynchronous manner. When the database management server 1000 acquires the data blocks in the asynchronous manner, a maximum bandwidth provided by the persistent storage medium 3000 may be utilized to reduce the database recovery time.

When the database management server 1000 acquires the data blocks from the persistent storage medium 3000 in a synchronous manner, a read request for other data blocks may be restricted until a read operation for one data block ends in the persistent storage medium 3000. Accordingly, the database management server 1000 is maintained in an idle state until the reading operation ends in the persistent storage medium 3000 and the data block is thus acquired.

However, according to the exemplary embodiment of the present disclosure, when the database management server 1000 acquires the data blocks in the asynchronous manner, the read request for other data blocks may be superimposed and waited in the persistent storage medium 3000 irrespective of whether the read operation for one data block ends. That is, an operation of recovering the data block acquired by the database management server 1000 and an operation of reading the data blocks in the persistent storage medium 3000 may be independently performed.

When a time required for an input/output process (a process of requesting and acquiring data during a database recovery process) for the persistent storage medium 3000 is longer than a data processing time, a method for acquiring the data block in the asynchronous manner may reduce the database recovery time.

The component of the database management system illustrated in FIG. 1 is not limited to the aforementioned exemplary embodiment.

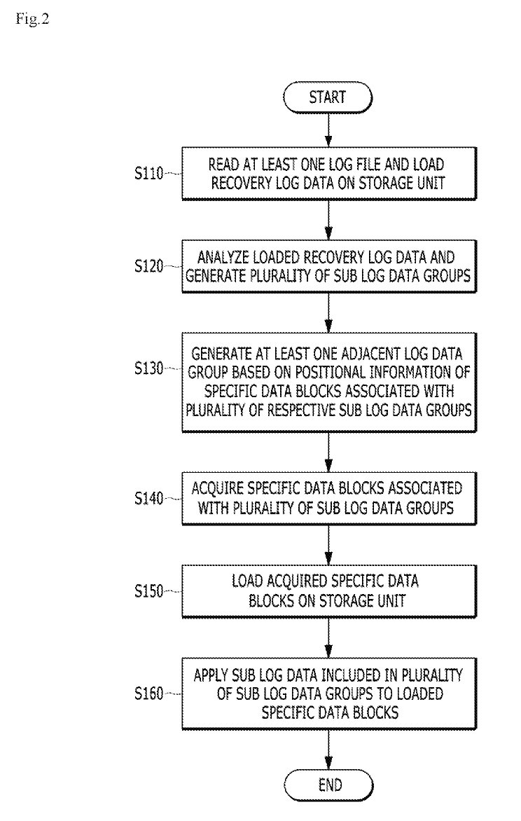

FIG. 2 illustrates a step of improving a recovery speed of a database by using log data sorting according to an exemplary embodiment of the present disclosure.

According to the exemplary embodiment of the present disclosure, the database management server 1000 may perform a step S110 of reading at least one redo log file and loading recovery log data on a storage unit 200, a step S120 of analyzing the loaded recovery log data and generating a plurality of sub log data groups, a step S130 of generating at least one adjacent log data group based on positional information of the specific data blocks associated with the plurality of respective sub log data groups, a step S140 of acquiring the specific data blocks associated with the plurality of sub log data groups, a step S150 of loading the acquired specific data blocks on the storage unit 200, and a step S160 of applying sub log data of the plurality of sub log data groups to the loaded specific data blocks.

In step S110, the database management server 1000 reads at least one log file to load the recovery log data on the storage unit 200. For example, the database management server 1000 may detect the redo log file required for the database recovery in all log file sets stored in the persistent storage medium 3000. In addition, the database management server 1000 may collect the recovery log data required for the database recovery in the redo log file and load the collected recovery log data on the storage unit 200.

In step S120, the database management server 1000 analyzes the loaded recovery log data to generate the plurality of sub log data groups.

According to the exemplary embodiment of the present disclosure, the database management server 1000 may classify the recovery log data loaded on the storage unit 200 for each associated specific data block. In addition, the database management server 1000 may generate the plurality of sub log data groups based on a classification result. Herein, each of the plurality of sub log data groups may include the sub log data.

For example, the database management server 1000 may classify the recovery log data loaded on the storage unit 200 for each of a data block having “block address: 1” and a data block having “block address: 2”. In addition, the database management server 1000 may generate two sub log data groups based on the classified recovery log data. In this case, each of two sub log data groups y include the sub log data.

In this case, the database management server 1000 may sort the sub log data of the sub log data group in the order of the change time of the associated specific data block.

For example, the database management server 1000 may sort the sub log data in the order of the change time of the specific data block associated with the sub log data. The sub log data are sorted to be continuously applied to the specific data block.

According to the exemplary embodiment of the present disclosure, the plurality of respective sub log data groups may be associated with the specific data blocks and the specific data blocks associated with the plurality of respective sub log data groups may be different from each other. When the specific data block is associated with the sub log data group, all sub log data of the sub log data group may include the change history for the specific data block.

For example, the specific data block associated with a first sub log data group may mean a data block in which positional information is “block address: 1” and in this case, all sub log data of the first sub log data group may be applied to the data block in which the positional information is “block address: 1”. In addition, the specific data block associated with a second sub log data group may mean a data block in which the positional information is “block address: 2” and all sub log data of the second sub log data group may be applied to the data block in which the positional information is “block address: 2”. As described above, address information of the data blocks to which the sub log data of the first and second sub log data groups are applied may be different from each other.

The database management server 1000 generates the plurality of sub log data groups to sort the sub log data in which the associated data blocks are the same as each other.

In step S130, the database management server 1000 may generate at least one adjacent log data group based on the positional information of the specific data blocks associated with the plurality of respective sub log data groups.

According to the exemplary embodiment of the present disclosure, the database management server 1000 may analyze the positional information of the specific data blocks associated with the plurality of sub log data groups. In addition, the database management server 1000 may identify the plurality of specific sub log data groups in which positions of the associated specific data blocks are adjacent to each other based on the analysis result. The database management server 1000 may generate at least one adjacent log data group based on the identification result.

For example, the database management server 1000 may analyze the positional information of the specific data blocks associated with five sub log data groups and identify the sub log data groups (the sub log data group associated with the data block having “block address: 1” and the sub log data group associated with the data block having “block address: 2”) of which positions are adjacent to each other in the persistent storage medium 3000. In addition, the adjacent log data group may be generated by the two sub log data groups. In this case, the database management server 1000 may acquire the specific data blocks (the data block having “block address: 1” and the data block having “block address: 2”) associated with the adjacent log data groups from the persistent storage medium 3000 at one time.

According to the exemplary embodiment of the present disclosure, a case where at least two specific data blocks are adjacent to each other in the persistent storage medium 3000 may include a case where a distance between at least two specific data blocks is less than a predetermined distance. For example, the database management server 1000 may determine the positions based on the positional information of at least two specific data blocks and compare the distance between at least two specific data blocks with the predetermined distance. In addition, when the distance between at least two specific data blocks is shorter than the predetermined distance, the database management server 1000 may determine that at least two specific data blocks are adjacent to each other. Herein, the predetermined distance may be predetermined by the database management server 1000.

According to another exemplary embodiment of the present disclosure, the case where at least two specific data blocks are adjacent to each other in the persistent storage medium 3000 may include a case where specific data blocks are close to each other so as for the database management server 1000 to acquire the corresponding specific data blocks from the persistent storage medium 3000 at one time.

For example, when the specific data block associated with the first sub log data group is “block address: 1” and the specific data block associated with the second sub log data group is “block address: 2”, the database management server 1000 may determine the position of the specific data blocks in the persistent storage medium 3000 based on the positional information of the specific data blocks. In addition, when it is determined that the specific data blocks may be acquired from the persistent storage medium at one attempt, the database management server 1000 may determine that the first and second sub log data groups are adjacent to each other. The database management server 1000 may generate the first adjacent log data group including the adjacent first and second sub log data groups.

According to the exemplary embodiment of the present disclosure, the database management server 1000 may sort at least one adjacent log data group. For example, when the first sub log data group and the fifth sub log data group are included in the first adjacent log data group, the first sub log data group and the fifth sub log data group may be sorted in at least a part of the storage unit 200 in line. In this case, the database management server 1000 may request the persistent storage medium 3000 to transmit the specific data blocks at one time based on the first sub log data group and the fifth sub log data group stored in at least a part of the storage unit 200 in line. Accordingly, when the database management server 1000 sorts at least one adjacent log data group, the number of times of accessing the persistent storage medium 3000 by the database management server 1000 may be reduced.

In step S140, the database management server 1000 may acquire the specific data blocks associated with the plurality of sub log data groups.

According to the exemplary embodiment of the present disclosure, the database management server 1000 may acquire the specific data blocks associated with the plurality of sub log data groups from the persistent storage medium 3000.

For example, the database management server 1000 may acquire an A data block associated with the first sub log data group from the persistent storage medium 3000.

According to the exemplary embodiment of the present disclosure the database management server 1000 may acquire the specific data blocks positioned to be adjacent to each other in the persistent storage medium 3000 at one time.

For example, when the first sub log data group (the positional information of the associated specific data block is “block address: 1”) and the second sub log data group (the positional information of the associated specific data block is “block address: 2”) are included in the first adjacent log data group, the database management server 1000 may acquire the specific data blocks (the data block in which the positional information is “block address: 1” and the data block in which the positional information is “block address: 2”) associated with the first adjacent log data group from the persistent storage medium 3000 at one time.

In step S150, the database management server 1000 may load the acquired specific data blocks on the storage unit 200.

According to the exemplary embodiment of the present disclosure, the database management server 1000 loads the specific data blocks of which recovery is required on the storage unit 200 and applies the sub log data to the loaded specific data blocks to perform the recovery.

In step S160, the database management server 1000 may apply the sub log data of the plurality of sub log data groups to the loaded specific data blocks.

According to the exemplary embodiment of the present disclosure, the database management server 1000 may apply the sub log data associated with the specific data blocks of the plurality of sub log data groups, respectively to the specific data blocks loaded on the storage unit 200. In this case, the sub log data are sorted in the order of the change time of the associated data block to be stored in at least a part of the storage unit 200.

For example, when the A data block is loaded on the storage unit 200, the sub log data of the first sub log data group associated with the A data block may be applied to the A data block of the storage unit 200. In addition, since the sub log data is stored in the order of the change time of the A data block, the sub log data may be continuously applied to the A data block.

According to the exemplary embodiment of the present disclosure, the database management server 1000 may apply the sub log data associated with the specific data blocks of the adjacent log data groups, respectively to the specific data blocks loaded on the storage unit 200. In this case, the sub log data are sorted in the order of the change time of the associated data block to be stored in at least a part of the storage unit 200.

For example, when the positional information of the specific data blocks loaded on the storage unit 200 is “block address: 1” and “block address: 2”, the database management server 1000 may continuously apply the sorted sub log data (the sub log data associated with the data block having “block address: 1” and the sub log data associated with the data block having “block address: 2”) to the specific data blocks, respectively. Herein, the sub log data may be sorted in the order of the change time of the specific data blocks so as to be continuously applied to the specific data blocks.

The steps described above in FIG. 2 are just an exemplary embodiment for describing the present disclosure and the present disclosure is not limited thereto. Further, at least one of the steps may be excluded or added.

Various embodiments described herein may be implemented in a computer-readable recording medium or a recording medium and a storage medium readable by a device similar to the computer by using, for example, software, hardware, or a combination thereof.

According to hardware implementation, the embodiment described herein may be implemented by using at least one of the application specific integrated circuits (ASICs), the digital signal processors (DSPs), the digital signal processing devices (DSPDs), the programmable logic devices (PLDs), the field programmable gate arrays (FPGAs), the processors, the controllers, the micro-controllers, the microprocessors, and the electric units for performing other functions. In some cases, the embodiments described in the specification may be implemented by the controller 100 itself.

According to software implementation, embodiments such as a procedure and a function described in the specification may be implemented by separate software modules. Each of the software modules may perform one or more functions and operations described in the specification. A software code may be implemented by a software application written by an appropriate program language. The software code may be stored in the storage unit 200 and executed by the control unit 100.

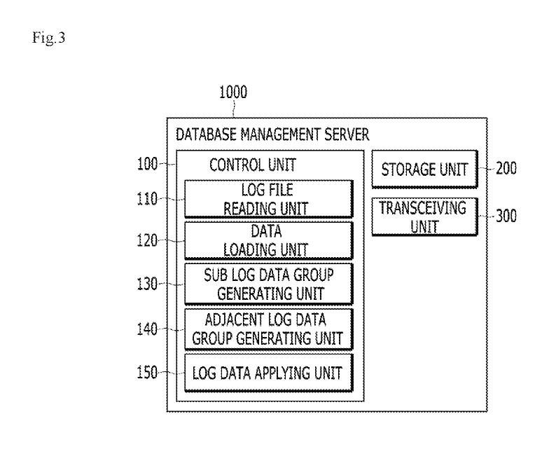

FIG. 3 illustrates internal components of a database management server according to an exemplary embodiment of the present disclosure.

According to the exemplary embodiment of the present disclosure, the database management server 1000 may include a control unit 100, a storage unit 200, and a transceiving unit 300. In addition, the control unit 100 may include a log file reading unit 110, a data loading unit 120, a sub log data group generating unit 130, an adjacent log data group generating unit 140, and a log data applying unit 150.

The log file reading unit 110 may read at least one log file. Herein, reading the log file may include detecting the redo log file required for the recovery among all log files of the persistent storage medium 3000 and analyzing the recovery log data of the redo log file.

The data loading unit 120 may load the recovery log data read by the log file reading unit 110 on the storage unit 200. Further, the data loading unit 120 may load the specific data blocks acquired from the persistent storage medium 3000 on the storage unit 200.

The sub log data group generating unit 130 analyzes the recovery log data loaded on the storage unit 200 to generate a plurality of sub log data groups. The sub log data group may include sub log data and each sub log data group may be associated with the specific data block. In addition, the specific data blocks associated with the plurality of sub log data group, respectively may be different from each other.

When the specific data block is associated with the sub log data group, all sub log data of the sub log data group may include a change history for the specific data block.

For example, the specific data block associated with a first sub log data group may mean a data block in which positional information is “block address: 1” and all sub log data of the first sub log data group may be applied to the data block in which the positional information is “block address: 1”. In addition, the specific data block associated with a second sub log data group may mean a data block in which the positional information is “block address: 2” and all sub log data of the second sub log data group may be applied to the data block in which the positional information is “block address: 2”. As described above, the data blocks to (with) which the sub log data of the first and second sub log data groups are applied (associated) may be different from each other.

The sub log data group generating unit 130 generates the plurality of sub log data groups to sort the sub log data in which the data blocks to be applied (associated) are the same as each other.

According to the exemplary embodiment of the present disclosure, the sub log data group generating unit 130 may classify the recovery log data for each associated specific data block. In addition, the sub log data group generating unit 130 may generate the plurality of sub log data groups based on the classification result. In this case, each of the plurality of sub log data groups may include the sub log data.

For example, the sub log data group generating unit 130 may classify log data in which the associated specific data block is A and log data in which the associated specific data block is B among the recovery log data. In addition, the classified log data are grouped to generate the first sub log data group and the second sub log data group. In this case, the first sub log data group may be associated with the A data block and the second sub log data group may be associated with the B data block.

According to the exemplary embodiment of the present disclosure, the sub log data group generating unit 130 may sort the sub log data of the sub log data group in the order of the change time of the associated specific data block.

For example, when there is the sub log data associated with the A data block, the sub log data group generating unit 130 may resort the sub log data in the order of the change time of the A data block. In this case, the log data applying unit 150 may continuously apply the sorted sub log data to the A data block.

The adjacent log data group generating unit 140 may generate at least one adjacent log data group based on the positional information of the specific data blocks associated with the sub log data sorted by the sub log data group generating unit 130.

According to the exemplary embodiment of the present disclosure, the adjacent log data group generating unit 140 may analyze the positional information of the specific data blocks associated with the plurality of sub log data groups. In addition, the adjacent log data group generating unit 140 may identify the plurality of specific sub log data groups in which positions of the associated specific data blocks are adjacent to each other based on the analysis result. In this case, the adjacent log data group generating unit 140 may generate at least one adjacent log data group based on the identification result.

For example, the adjacent log data group generating unit 140 may analyze the positional information of the A data block, the B data block, and a C data block associated with the first sub log data group, the second sub log data group, and a third sub log data group, respectively. In addition, the adjacent log data group generating unit 140 may analyze the positions of the A data block, the B data block, and the C data block in the persistent storage medium 3000. The adjacent log data group generating unit 140 may identify the adjacent specific data blocks based on the analysis result and when it is identified that the A data block and the B data block are adjacent to each other, a first adjacent log data group may be generated by the first sub log data group and the second sub log data group associated with the A data block and the B data block, respectively.

According to the exemplary embodiment of the present disclosure, a case where at least two specific data blocks are adjacent to each other in the persistent storage medium 3000 may include a case where a distance between at least two specific data blocks is less than a predetermined distance. For example, the database management server 1000 may determine the positions based on the positional information of at least two specific data blocks and compare the distance between at least two specific data blocks with the predetermined distance. In addition, when the distance between at least two specific data blocks is shorter than the predetermined distance, the database management server 1000 may determine that at least two specific data blocks are adjacent to each other. Herein, the predetermined distance may be predetermined by the database management server 1000.

According to another exemplary embodiment of the present disclosure, the case where at least two specific data blocks are adjacent to each other in the persistent storage medium 3000 may include a case where the positions of at least two specific data blocks are close to each other so as to acquire the specific data blocks from the persistent storage medium 3000 at one time.

For example, when the positional information of the specific data block associated with the first sub log data group is “block address: 1” and the positional information of the specific data block associated with the second sub log data group is “block address: 2”, the adjacent log data group generating unit 140 may determine the positions of the specific data blocks in the persistent storage medium 3000 based on the positional information of the specific data blocks. In addition, when the specific data blocks may be acquired from the persistent storage medium at one attempt, the adjacent log data group generating unit 140 may determine that the specific data blocks associated with the first and second sub log data groups are adjacent to each other. In this case, the adjacent log data group generating unit 140 may generate the first adjacent log data group including the adjacent first and second sub log data groups.

According to the exemplary embodiment of the present disclosure, the adjacent log data group generating unit 140 sorts the plurality of adjacent log data groups again, and as a result, the number of times of acquiring the data block from the persistent storage medium 3000 may he reduced.

The log data applying unit 150 continuously applies the sub log data loaded on at least a part of the storage unit 200 to the specific data blocks loaded on at least a part of the storage unit 200 to recover data files of the database. In this case, the sub log data may include the change history for each of the specific data blocks.

For example, when the positional information of the specific data blocks loaded on the storage unit 200 is “block address: 1” and “block address: 2”, the database management server 1000 may continuously apply the sorted sub log data (the sub log data associated with the data block in which the positional information is “block address: 1” and the data block in which the positional information is “block address: 2’, respectively) to the recovery target data block. In this case, the sub log data may be applied in the order of the change time of the specific data blocks.

The database management server 1000 may perform a database recovery by using the storage unit 200. For example, when the log file reading unit 110 of the database management server 1000 reads the redo log file, the data loading unit 12.0 may load the recovery log data on at least a part of the storage unit 200 and sort the sub log data in the sub log data group generating unit 130 and the adjacent log data group generating unit 140. The database management server 1000 may read the specific data blocks from the persistent storage medium 3000 through the transceiving unit 300 and store the read specific data blocks in at least a part of the storage unit 200. In addition, the log data applying unit 150 may apply the sub log data to the specific data blocks stored in at least a part of the storage unit 200.

Herein, the storage unit 200 as a primary storage device directly accessed by the control unit 100, such as a random access memory (RAM) including a dynamic random access memory (DRAM), a static random access memory (SRAM), etc. may mean a volatile storage device in which stored information is momentarily erased when power is turned off, but is not limited thereto. The storage unit 200 may be controlled by the control unit 100.

The transceiving unit 300 may transmit/receive data to/from the persistent storage medium 3000 through the network 2000. The transceiving unit 300 may acquire the specific data blocks from the persistent storage medium 3000 and transmit a data block of which recovery is completed to the persistent storage medium 3000.

According to the exemplary embodiment of the present disclosure, the transceiving unit 300 may acquire the specific blocks associated with the plurality of sub log data groups from the persistent storage medium 3000. In addition, the transceiving unit 300 may acquire the specific blocks associated with at least one adjacent log data group from the persistent storage medium 3000 at one time.

For example, the transceiving unit 300 may acquire the A data block and the B data block associated with the first adjacent log data group from the persistent storage medium 3000 at one time instead of two times.

According to the exemplary embodiment of the present disclosure, the transceiving unit 300 may acquire the specific data blocks associated with the plurality of sub log data groups in the asynchronous mariner.

For example, when the transceiving unit 300 needs to acquire the A data block and the B data block, the transceiving unit 300 acquires the A data block and completes the data recovery operation and thereafter, may acquire a next data block irrespective of whether the data recovery operation ends instead of acquiring the B data block.

Internal components of the database management server 1000 illustrated in FIG. 3 are not limited to the aforementioned components and the components such as the log file reading unit 110, the data loading unit 120, the sub log data group generating unit 130, the adjacent log data group generating unit 140, and the log data applying unit 150 of the control unit 100 array be implemented even as at least one processor.

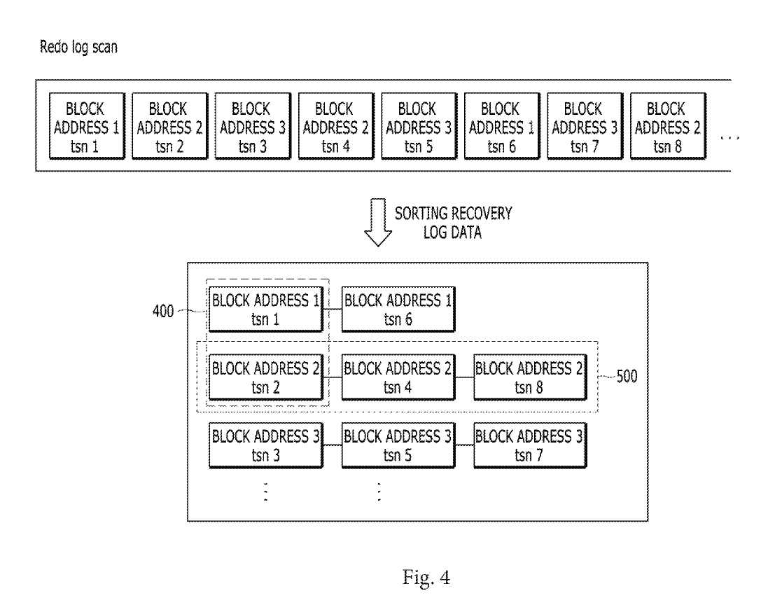

FIG. 4 illustrates a method in which a database management server generates a sub log data group and an adjacent log data group by sorting recovery log data according to an exemplary embodiment of the present disclosure.

According to the exemplary embodiment of the present disclosure, the database management server 1000 scans the redo log file of the persistent storage medium 3000 to acquire and store the recovery log data. In addition, the database management server 1000 analyzes the recovery log data to sort the recovery log data based on the specific data block to which the recover log data is to applied and generate the plurality of sub log data groups. Further, the database management server 1000 may generate at least one adjacent log data group based on the positional information of the specific data blocks associated with the plurality of sub log data groups.

According to the exemplary embodiment of the present disclosure, the case where the database management server 1000 generates the plurality of sub log data groups may include a case where the recovery log data are arranged according to the positional information (block address) of the associated specific data block like reference numeral 500. In this case, a case where the positional information is identical may include a case where the specific data block associated with the recovery log data is identical.

According to the exemplary embodiment of the present disclosure, the case where the database management server 1000 generates the plurality of adjacent log data groups may include a case where the plurality of sub log data groups is classified based on whether the specific data blocks associated with the sub log data group are adjacent to each other.

For example, like reference numeral 500 of FIG. 4, when the recovery log data in which the positional information of the associated specific data block is “block address: 2” is divided into three parts, the database management server 1000 binds three log data to generate the sub log data group. In this case, it may be assumed that the database management server 1000 generates the sub log data group associated with the specific data block in which the positional information is “block address: 2”.

Like reference numeral 500 of FIG. 4, when the sub log data group is generated, the database management server 1000 may compare the plurality of sub log data groups. In this case, the database management server 100 compares the positional information of the plurality of specific data blocks associated with the plurality of sub log data groups to generate at least one adjacent log data group. Like reference numeral 400, the database management server 1000 may determine whether the specific data blocks associated with two sub log data groups are adjacent to each other in the persistent storage medium 3000 based on the positional information (block address) and generate the adjacent log data group.

Herein, when the adjacent log data group is generated, the database management server 1000 may acquire the specific data blocks associated with the adjacent log data group from the persistent storage medium 3000 at one time. In addition, the sub log data associated with the specific data blocks are continuously applied by loading the acquired specific data blocks on the storage unit 200 to perform the database recovery. In this case, each of the sub log data may include the change history for each of the specific data blocks.

The database management server 1000 classifies and sorts the recovery log data for each specific data block associated with the recovery log data, and as a result, the number of times of acquiring the specific data blocks from the persistent storage medium 3000 by the database management server 1000 may be reduced.

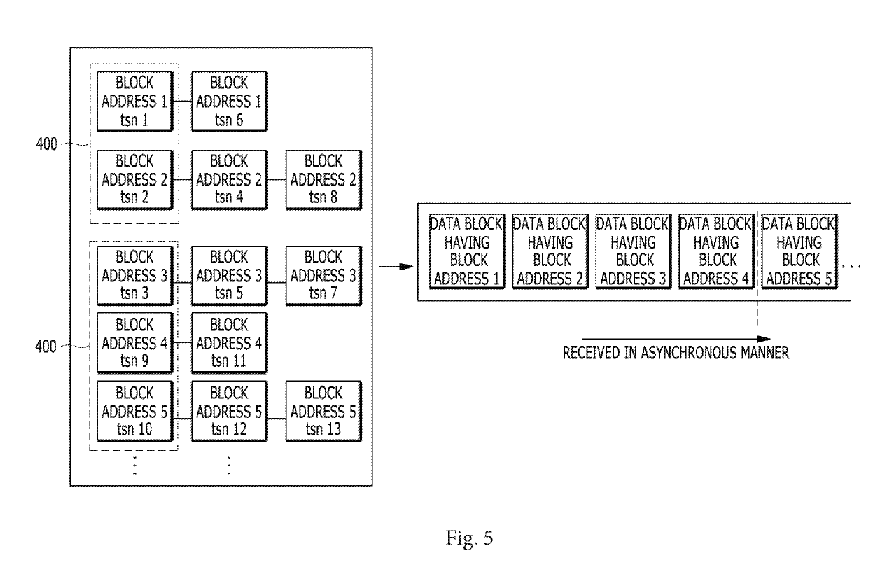

FIG. 5 illustrates a method in which a database management server acquires a plurality of adjacent data blocks by an asynchronous method according to an exemplary embodiment of the present disclosure.

According to the exemplary embodiment of the present disclosure, the database management server 1000 may acquire the specific data blocks associated with the adjacent log data group from the persistent storage medium 3000 in the asynchronous manner.

Herein, the case where the database management server 1000 acquires the specific data blocks in the asynchronous manner is a manner in which the persistent storage medium 3000 permits the database management server 1000 to continue a data transmission request until completing data transmission to the database management server 1000 and it may be effective to reduce the database recovery time when a time required for the input/output process (a process of requesting and acquiring the data during the database recovery process) in/from the persistent storage medium 3000 is longer than the data processing time.

For example, when the transceiving unit 300 needs to acquire the A data block and the B data block, the transceiving unit 300 acquires the A data block and completes the data recovery operation and thereafter, may acquire a next data block irrespective of whether the data recovery operation ends instead of acquiring the B data block.

According to the exemplary embodiment of the present disclosure, the case where at least two specific data blocks are adjacent to each other in the persistent storage medium 3000 may include a case where the positions depending on the block address information of at least two specific data blocks are close to each other so as to acquire the data blocks from the persistent storage medium 3000 at one time.

For example, when the specific data block associated with the first sub log data group is “block address: 1” and the specific data block associated with the second sub log data group is “block address: 2”, the database management server 1000 may determine the position of the specific data blocks in the persistent storage medium 3000 based on the address block of the specific data blocks. In addition, when the specific data blocks may be acquired from the persistent storage medium at one attempt, the database management server 1000 may determine that the first and second sub log data groups are adjacent to each other. The database management server 1000 may generate the first adjacent log data group including the adjacent first and second sub log data groups.

Referring to two adjacent log data groups 400 illustrated in FIG. 5, two sub log data groups having “block address: 1” and “block address: 2” are generated as the adjacent log data groups and three sub log data groups having “block address: 3”, “block address: 4”, and “block address: 5” are generated as the adjacent log data groups. Herein, two data blocks associated with two sub log data groups having “block address: 1” and “block address: 2” may be acquired from the persistent storage medium 3000 by the database management server 1000 at one time instead of two times. In addition, three data blocks associated with three sub log data groups having “block address: 3”, “block address: 4”, and “block address: 4” may be acquired from the persistent storage medium 3000 by the database management server 1000 at one time instead of three times.

According to the exemplary embodiment of the present disclosure, when the database management server 1000 acquires a plurality of recovery target data blocks from the persistent storage medium 3000, the database management server 1000 may acquire the recovery target data blocks in a predetermined unit and in the asynchronous manner.

Herein, the predetermined unit may include a bandwidth of the persistent storage medium 3000 and the present disclosure is not limited thereto.

When the database management server 1000 may acquire the recovery target data block in the asynchronous manner, a maximum bandwidth provided by the persistent storage medium 3000 may be utilized to reduce the database recovery time.

The case where the database management server 1000 may acquire the recovery target data block in the asynchronous manner is a manner to permit other processes to be continued until completing the data transmission and when the input/output process (the process of requesting and acquiring the data during the database recovery process) in/from the persistent storage medium 3000 requires a longer time than data processing, it may be effective in reducing the database recovery time.

For example, when the bandwidth of the persistent storage medium 3000 as the same size as two data blocks, the database management server 1000 may acquire two data blocks in which the positional information is “block address: 1” and “block address: 2” and subsequently acquire three data blocks in which the positional information is “block address: 3”, “block address: 4”, and “block address: 5” according to the bandwidth (having the size corresponding to the size of two data blocks) of the persistent storage medium 3000 in the asynchronous manner, as illustrated in FIG. 5.

The acquisition manner described above in FIG. 5 is just an exemplary embodiment for describing the present disclosure and a manner in which the database management server 1000 of the present disclosure acquires the specific data blocks is not limited to the aforementioned exemplary embodiment.

It will be appreciated by those skilled in the art that information and signals may be expressed by using various different predetermined technologies and techniques. For example, data., instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be analyzed that the implementation determination departs from the scope of the present disclosure.

Various exemplary embodiments presented herein may be implemented as manufactured articles using a method, an apparatus, or a standard programming and/or engineering technique. The term “manufactured article” includes a computer program, a carrier, or a medium which is accessible by a predetermined computer-readable device. Herein, the media may include storage media. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information, but are not limited thereto.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but it does not mean that the method claims are limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the embodiments presented herein, but should be analyzed within the widest range which is consistent with the principles and new features presented herein.

What is claimed is:

1. A method for improving a database recovery speed using a log data analysis, the method comprising:
reading at least one redo log file and loading recovery log data on a storage device;
analyzing the loaded recovery log data and generating a plurality of sub log data groups, the plurality of the respective sub log data groups being associated with specific data blocks and the specific data blocks associated with the plurality of the respective sub log data groups being different from each other; and
generating at least one adjacent log data group based on positional information of the specific data blocks associated with the plurality of the respective sub log data groups, each of the at least one adjacent log data group including at least one sub log data group.

2. The method of claim 1, wherein the generating of the plurality of the sub log data groups includes:
classifying the recovery log data for each of the associated specific data blocks, and
generating the plurality of the sub log data groups based on a result of the classification, each of the plurality of the sub log data groups including sub log data.

3. The method of claim 1, wherein the generating of the at least one adjacent log data group includes:
analyzing the positional information of the specific data blocks associated with the plurality of the sub log data groups,
identifying a plurality of specific sub log data groups in which positions of the associated specific data blocks are close to one another based on a result of the analysis of the positional information of the specific data blocks associated with the plurality of the sub log data groups, and
generating the at least one adjacent log data group based on a result of the identification.

4. The method of claim 1, further comprising:
acquiring the specific data blocks associated with the plurality of the sub log data groups from a persistent storage medium;
loading the acquired specific data blocks on the storage device and applying the sub log data included in the plurality of the sub log data groups to the loaded specific data blocks, the applied sub log data being associated with the loaded specific data blocks, respectively.

5. The method of claim 4, further comprising:
sorting the sub log data in the order of a change time of the associated specific data blocks,
wherein in the applying of the sub log data to the loaded specific data blocks, the sorted sub log data are sequentially applied to the loaded specific data blocks.

6. The method of claim 4, wherein in the acquiring of the specific data blocks from the persistent storage medium, the specific data blocks associated with the at least one adjacent log data group are acquired from the persistent storage medium at one time,

7. The method of claim 4, wherein in the acquiring of the specific data blocks from the persistent storage medium, the specific data blocks associated with the plurality of the sub log data groups are acquired in an asynchronous manner.

8. A database management server having memory and a processor for providing a method for improving a database recovery speed using a log data analysis, the database management server comprising:
a log file reader configured to read at least one redo log file;
a data loader configured to load recovery log data on a storage device;
a sub log data group generator configured to analyze the loaded recovery log data and generate a plurality of sub log data groups, the plurality of the respective sub log data groups being associated with specific data blocks and the specific data blocks associated with the plurality of the respective sub log data groups being different from each other; and
an adjacent log data group generator configured to generate at least one adjacent log data group based on positional information of the specific data blocks associated with the plurality of the respective sub log data groups, each of the at least one adjacent log data group including at least one sub log data group.

9. A non-transitory computer-readable medium including a computer program including encoded commands, which is configured to cause one or more processors to perform a process when the computer program is executed by the one or more processors of a computer system, wherein the process comprises:
reading at least one redo log file and loading recovery log data on a storage device;
analyzing the loaded recovery log data and generating a plurality of sub log data groups, the plurality of the respective sub log data groups being associated with specific data blocks and the specific data blocks associated with the plurality of the respective sub log data groups being different from each other; and
generating at least one adjacent log data group based on positional information of the specific data blocks associated with the plurality of the respective sub log data groups, each of the at least one adjacent log data group including at least one sub log data group.
